(19) United States
(12) Patent Application Publication
(10) Pub. No.: US 2026/0064263 A1
(43) Pub. Date: Mar. 5, 2026

(54) DETECTION SYSTEM

(71) Applicant: Japan Display Inc., Tokyo (JP)

(72) Inventor: Hiroyuki WAKANA, Tokyo (JP)

(21) Appl. No.: 19/318,773

(22) Filed: Sep. 4, 2025

(30) Foreign Application Priority Data
Sep. 5, 2024 (JP) 2024-152979

(51) Int. Cl. G06F 3/0488; G06F 3/044; G06F 3/04812

(52) U.S. Cl. CPC G06F 3/0488; G06F 3/0446; G06F 3/04812; G06F 2203/04107

(57) ABSTRACT

According to an aspect, a detection system includes: a detection device including a plurality of sensor electrodes provided in a detection region, and a detection circuit configured to detect capacitance of each of the sensor electrodes; a display device having a display region overlapping the detection region; and a control device configured to control the detection device and the display device. The detection device is configured to calculate spatial coordinates of an object to be detected. The control device is configured to control the display device so as to display a cursor at a position where the calculated spatial coordinates of the object to be detected are projected onto the display region.

### CROSS-REFERENCE TO RELATED APPLICATION

This application claims the benefit of priority from Japanese Patent Application No. 2024-152979 filed on Sep. 5, 2024, the entire contents of which are incorporated herein by reference.

### BACKGROUND

### 1. Technical Field

What is disclosed herein relates to a detection system.

### 2. Description of the Related Art

In recent years, widely known are detection systems, what are called touch panels, in which a detection device capable of detecting an external proximity object is mounted on or integrated with a display device, such as a liquid crystal display device (refer to WO 2019/082399, for example).

When tapping a button or writing characters or pictures in a hover operation on the detection system described in WO 2019/082399, a user may fail to recognize how high from a detection surface the button can be tapped in the space on the detection surface or how high the user can write the characters or pictures.

For the foregoing reasons, there is a need for a detection system that enables a user to visually recognize the degree of operation in a space.

### SUMMARY

According to an aspect, a detection system includes: a detection device including a plurality of sensor electrodes provided in a detection region, and a detection circuit configured to detect capacitance of each of the sensor electrodes; a display device having a display region overlapping the detection region; and a control device configured to control the detection device and the display device. The detection device is configured to calculate spatial coordinates of an object to be detected. The control device is configured to control the display device so as to display a cursor at a position where the calculated spatial coordinates of the object to be detected are projected onto the display region.

### BRIEF DESCRIPTION OF THE DRAWINGS

FIG. 1 is a plan view of a schematic configuration of a detection device according to an embodiment;

FIG. 2 is a schematic of a sectional configuration of a detection system in which the detection device according to the embodiment is used;

FIG. 3 is a block diagram of an exemplary configuration of a detection circuit of the detection device according to the embodiment;

FIG. 4 is a block diagram of an exemplary configuration of a control device of the detection device according to the embodiment;

FIG. 5A is a schematic of the relation between the position of an object to be detected in a space on a detection region and the positions of respective sensor electrodes;

FIG. 5B is a schematic of the spatial coordinates of the object to be detected in the space on the detection region;

FIG. 6 is a schematic for explaining changes of a cursor;

FIG. 7 is a schematic of the position of a determination plane when the size of an object to be operated is small;

FIG. 8 is a schematic of the position of the determination plane when the size of the object to be operated is large;

FIG. 9 is a graph indicating the relation between the size of the object to be operated and the distance from a detection surface to the determination plane;

FIG. 10 is a flowchart of an example of a process of displaying the cursor in the detection device according to the embodiment;

FIG. 11 is a sub-flowchart of an example of a cursor creation process illustrated in FIG. 10;

FIG. 12 is a sub-flowchart of an example of a process of determining the type or size of the cursor illustrated in FIG. 11;

FIG. 13 is a schematic for explaining the method for determining the cursor size when the distance from a detection start plane to the determination plane is long;

FIG. 14 is a schematic for explaining the method for determining the cursor size when the distance from the detection start plane to the determination plane is short;

FIG. 15 is a schematic for explaining the method for determining the cursor size when the distance from the detection start plane to the determination plane is long and illustrates an example different from FIG. 13; and

FIG. 16 is a schematic for explaining the method for determining the cursor size when the distance from the detection start plane to the determination plane is short and illustrates an example different from FIG. 14.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To make the explanation more specific, the drawings may possibly illustrate the width, the thickness, the shape, and other elements of each component more schematically than the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be omitted as appropriate.

### Embodiment

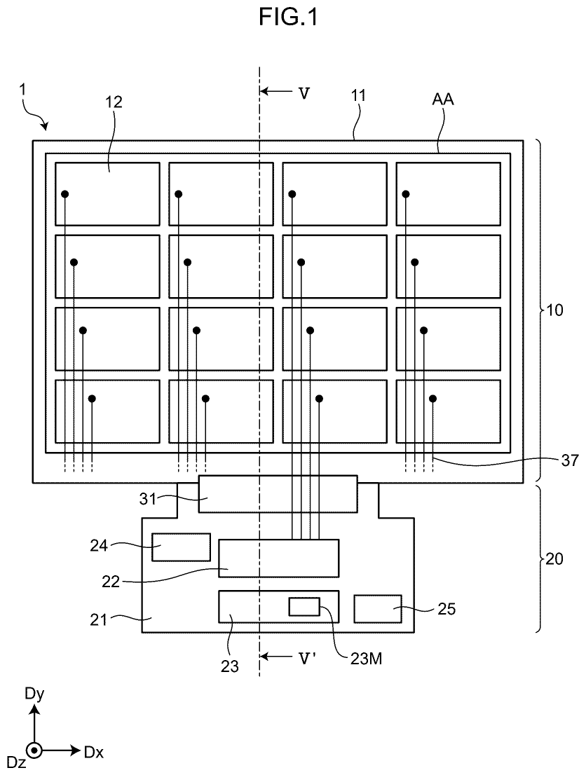

FIG. 1 is a plan view of a schematic configuration of a detection device according to an embodiment. As illustrated in FIG. 1, a detection device 1 includes a sensor 10 and a detector 20.

The sensor 10 includes a sensor substrate 11, a plurality of sensor electrodes 12 provided in a detection region AA of the sensor substrate 11, and wiring 37 extending from the sensor electrodes 12. The detector 20 includes a control substrate 21, a detection circuit 22, a processing circuit 23, a power supply circuit 24, and an interface circuit 25.

The detection region AA of the sensor substrate 11 is a region provided with the sensor electrodes 12 arrayed in a matrix (row-column configuration) in a first direction Dx and a second direction Dy. FIG. 1 illustrates a configuration in which M (four in FIG. 1) sensor electrodes 12 are arrayed in the first direction Dx and N (four in FIG. 1) sensor electrodes 12 are arrayed in the second direction Dy. The sensor substrate 11 is a glass substrate or light-transmitting flexible printed circuits (FPC), for example.

In the present disclosure, the first direction Dx and the second direction Dy are orthogonal in the detection region AA of the sensor substrate 11. In the present disclosure, the direction orthogonal to the first direction Dx and the second direction Dy is referred to as a third direction Dz.

While FIG. 1 illustrates an example where 4×4 (=16) sensor electrodes 12 with four sensor electrodes 12 in the first direction Dx and four sensor electrodes 12 in the second direction Dy are provided, the number of sensor electrodes 12 provided in the detection region AA of the sensor substrate 11 is not limited thereto.

The sensor substrate 11 is electrically coupled to the control substrate 21 via a wiring substrate 31. The wiring substrate 31 is flexible printed circuits, for example. Each sensor electrode 12 of the sensor 10 is coupled to the detection circuit 22 of the detector 20 via the wiring substrate 31.

The control substrate 21 is provided with the detection circuit 22, the processing circuit 23, the power supply circuit 24, and the interface circuit 25. The control substrate 21 is a rigid board, for example.

The detection circuit 22 generates a detection value of each sensor electrode 12 based on a detection signal of the sensor electrode 12 output from the sensor substrate 11. The detection circuit 22 is an analog front-end (AFE) IC, for example.

The processing circuit 23 generates the spatial coordinates indicating the position of an object to be detected (e.g., operator's finger) on or above the detection region AA based on the detection values of the sensor electrodes 12 that are output from the detection circuit 22. The processing circuit 23 may be a programmable logic device (PLD), such as a field programmable gate array (FPGA), or a micro control unit (MCU), for example. The processing circuit 23 includes a memory 23M.

The memory 23M stores therein thresholds serving as the criteria for determining whether an object to be detected Fg is present in the detection region by the processing circuit 23 and the criteria for determining whether to detect an input operation performed by a user.

The power supply circuit 24 is a circuit that supplies power to the detection circuit 22 and the processing circuit 23.

The interface circuit 25 is a USB controller IC, for example, and is a circuit that controls communications between the processing circuit 23 and a host controller (not illustrated) of a control device HD, which will be described later, on which the detection system is mounted.

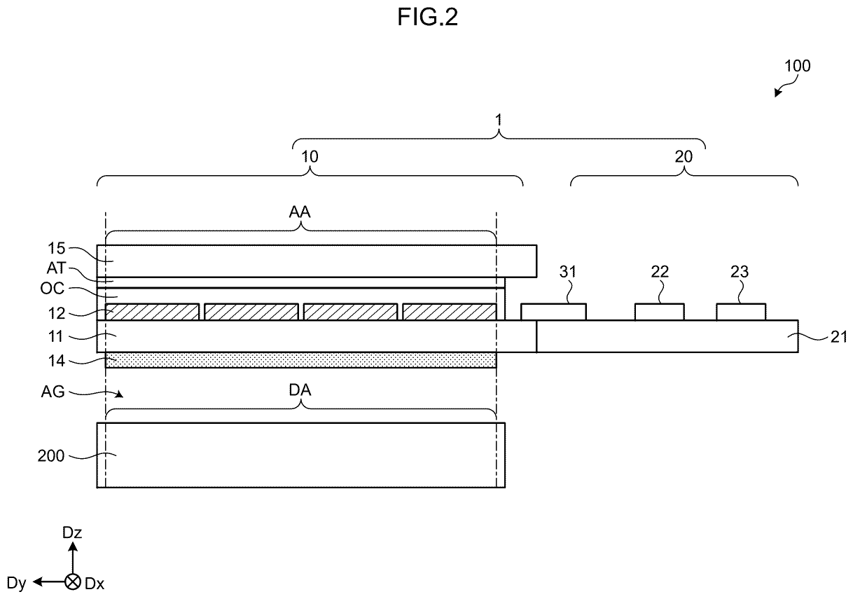

FIG. 2 is a schematic of a sectional configuration of the detection system in which the detection device according to the embodiment is used. FIG. 2 illustrates a section along line II-II′ of FIG. 1. A detection system 100 includes the detection device 1 and a display device 200. The display device 200 is disposed facing the sensor 10 of the detection device 1 with an air gap AG interposed therebetween. The sensor 10 of the detection device 1 is disposed such that the detection region AA of the sensor 10 and a display region DA of the display device 200 overlap when viewed in the third direction Dz in plan view.

The sensor 10 includes the sensor substrate 11, the sensor electrodes 12, a shield 14, and a front plate 15. The sensor substrate 11 is a light-transmitting substrate, such as glass and resin. The sensor substrate 11 is provided with the sensor electrodes 12. A protective layer OC covers the sensor electrodes 12 to flatten the surface and protect the sensor electrodes 12. The protective layer OC is made of a light-transmitting resin, and more specifically, of acrylic resin, for example. The protective layer OC is not necessarily made of an organic resin and may be made of an inorganic resin, or may be a multilayered body of an organic resin and an inorganic resin.

The front plate 15 is a protective panel that protects the front surface of the detection device. The front plate 15 is also called a cover glass if it is a glass substrate. The front plate 15 is stacked on the sensor substrate 11 in the third direction Dz orthogonal to the surface of the front plate 15. The sensor substrate 11 is fixed to the front plate 15 with an adhesive layer AT interposed therebetween. The adhesive layer AT is made of a light-transmitting adhesive and is called an optical clear adhesive (OCA). The adhesive layer AT may be a light-transmitting film with double-sided adhesion.

The shield 14, the sensor substrate 11, and the front plate 15 of the sensor 10 are stacked in this order on the display device 200.

The shield 14 is made of light-transmitting conductive material, such as indium tin oxide (ITO), indium zinc oxide (IZO), and indium gallium oxide (IGO). The shield 14 is provided to a second surface of the sensor substrate 11 facing the display device 200.

The sensor electrodes 12 are provided to a first surface opposite to the second surface of the sensor substrate 11. In the following description, the surface of the front plate 15 provided to the top layer is also referred to as a “detection surface S”.

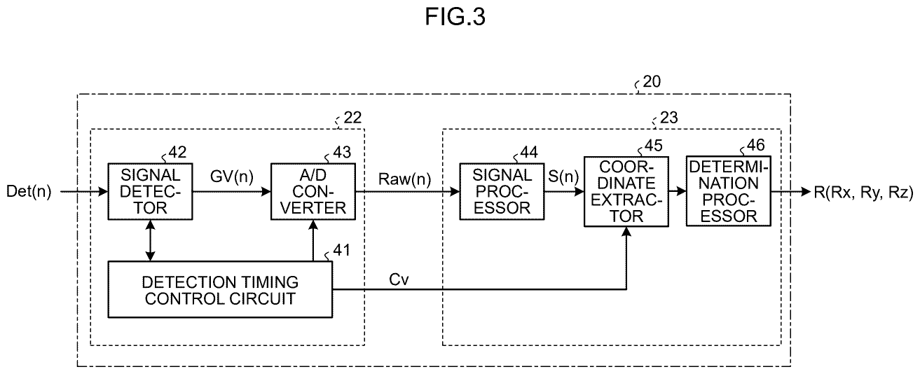

The display device 200 is a liquid crystal display (LCD), for example. The display device 200 may be an organic light-emitting diode (OLED) display or an inorganic EL display (micro-LED or mini-LED), for example. FIG. 3 is a block diagram of an exemplary configuration of the detection circuit of the detection device 1 according to the embodiment. As illustrated in FIG. 3, the detector 20 includes a detection timing control circuit 41, a signal detector 42, an analog-to-digital (A/D) converter 43, a signal processor 44, a coordinate extractor 45, and a determination processor 46. In the present disclosure, the detection timing control circuit 41, the signal detector 42, and the A/D converter 43 are included in the detection circuit 22. The signal processor 44, the coordinate extractor 45, and the determination processor 46 are included in the processing circuit 23.

The detection timing control circuit 41 controls the detection operation timing of the signal detector 42 and the A/D converter 43.

The signal detector 42 generates an output value GV(n) of each sensor electrode 12 based on a detection signal Det(n) (n is a natural number from 1 to N, where N is the number of the sensor electrodes in the detection region AA) of the sensor electrode 12 output from the sensor substrate 11.

The A/D converter 43 converts the output value GV(n) of the signal detector 42 into a discrete detection value Raw(n) by sampling the output value.

The signal processor 44 performs predetermined signal processing on the detection value Raw(n) of each sensor electrode 12 and calculates a signal value S (n) of the sensor electrode 12.

The coordinate extractor 45 extracts the spatial coordinates of the position of an object to be detected Fg, based on the detection value S(n) of each sensor electrode 12 output from the signal processor 44.

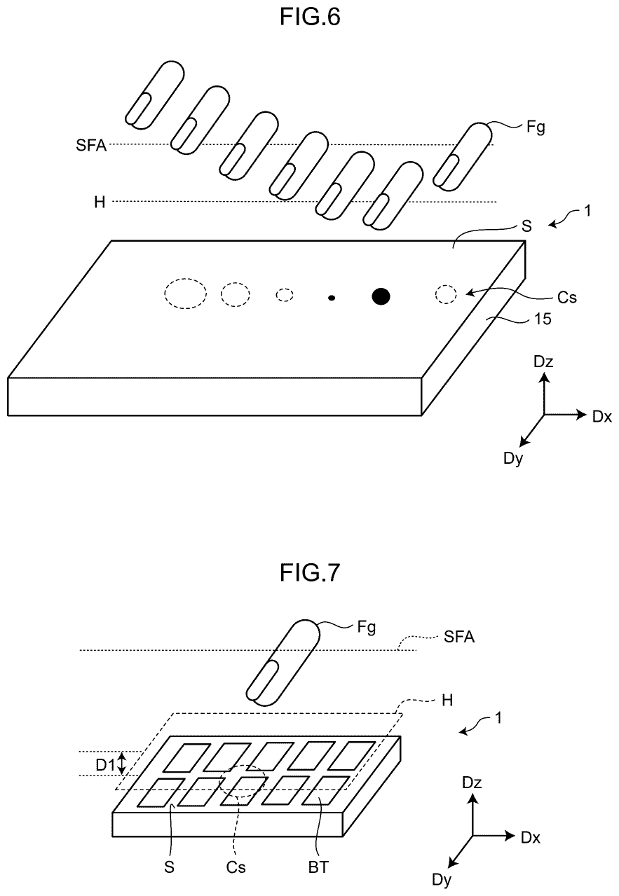

Based on the spatial coordinates R(Rx, Ry, Rz) calculated by the coordinate extractor 45, the determination processor 46 determines whether the object to be detected Fg is approaching the detection surface S beyond a detection start plane SFA or a determination plane H, which will be described later with reference to FIG. 6.

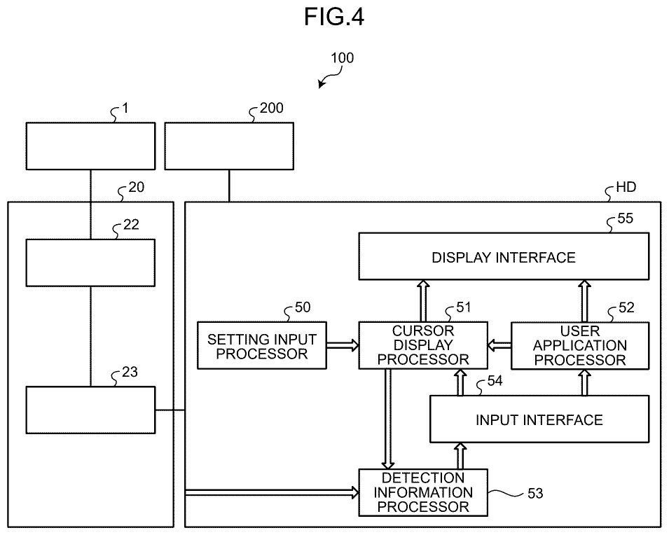

FIG. 4 is a block diagram of an exemplary configuration of the control device of the detection device according to the embodiment.

As illustrated in FIG. 4, the detection system 100 includes the control device HD provided externally and coupled to the detector 20. The control device HD controls the detection device 1 and the display device 200.

The control device HD includes, for example, a central processing unit (CPU) and a storage device, such as a memory. The control device HD executes computer programs using these hardware resources, thereby implementing various functions, such as a setting input processor 50, a cursor display processor 51, a user application processor 52, and a detection information processor 53. The control device HD further includes an input interface 54 and a display interface 55.

As illustrated in FIG. 4, signals between the detection circuit 22 and the processing circuit 23 are transmitted by a serial peripheral interface (SPI), which is a clock synchronous interface. The serial interface for transmitting the signals between the detection circuit 22 and the processing circuit 23 is not limited to SPI.

Signals between the processing circuit 23 and the control device HD are transmitted by USB, which is a serial interface. Specifically, the signals between the processing circuit 23 and the control device HD are transmitted via a signal line of a USB cable. The serial interface for transmitting the signals between the processing circuit 23 and the control device HD is not limited to USB.

The detector 20 transmits coordinate data to a driver IC. The detection information processor 53 supplies video signals to the display device 200 and drives the display device 200.

The setting input processor 50 receives information on a determination plane H set by the user. The setting input processor 50 transmits the positional information of the set determination plane H to the cursor display processor 51. The cursor display processor 51 transmits the positional information of the determination plane H to the detection information processor 53.

The cursor display processor 51 outputs display data of a cursor Cs to the display device 200 via the display interface 55. The detection device 1 calculates the spatial coordinates R of the object to be detected Fg. The control device HD controls the display device 200 so as to display the cursor Cs at the position where the calculated spatial coordinates R of the object to be detected Fg is projected onto the display region DA.

The detection information processor 53 transmits the coordinate information of the object to be detected Fg to the cursor display processor 51 via the input interface 54.

The user application processor 52 is a processor that performs functions desired by the user. The present disclosure describes, as an example, an object to be operated BT assigned as a target of an input operation to perform the function desired by the user. The user application processor 52 stores the positional information of the set determination plane H in the memory for an input operation on the object to be operated BT. The user application processor 52 transmits, to the cursor display processor 51, the positional information of the determination plane H read from the memory and the size information of the object to be operated BT. The object to be operated BT is a graphical user interface (GUI) for receiving operations relating to various kinds of processing on the display device 200 from the user. The object to be operated BT is displayed in the display region DA of the display device 200, and the display image of the object to be operated BT is superimposed on the detection region AA.

The cursor display processor 51 transmits, to the detection information processor 53, the positional information of the determination plane H or the size information of the object to be operated BT. The detection information processor 53 transmits the positional information of the determination plane H or the size information of the object to be operated BT, to the cursor display processor 51 and the user application processor 52 via the input interface 54.

The user application processor 52 outputs an application display screen to the display device 200 via the display interface 55.

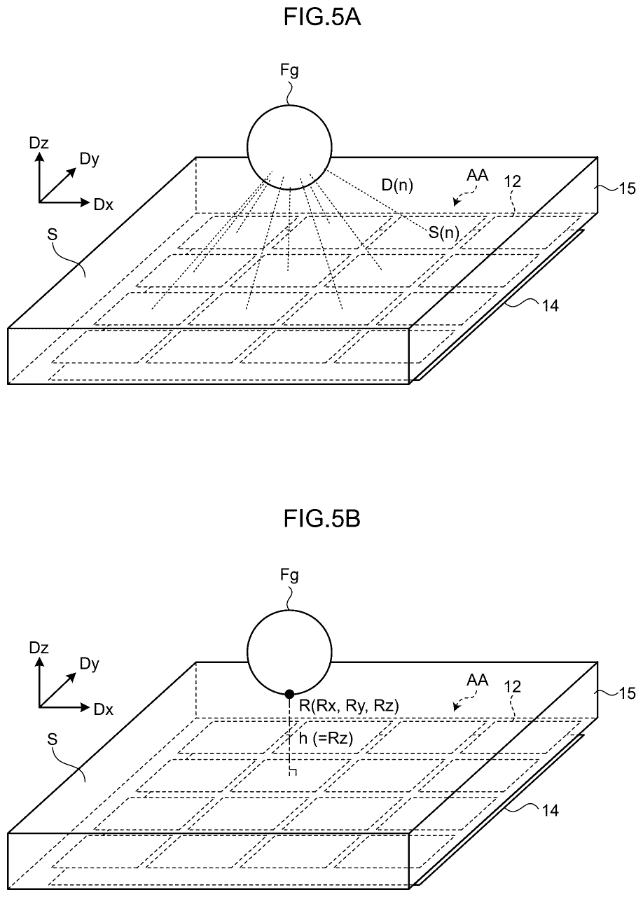

FIG. 5A a schematic of the relation between the position of the object to be detected in a space on the detection region and the positions of the respective sensor electrodes. As illustrated in FIG. 5A, each sensor electrode 12 in the detection region AA generates capacitance corresponding to a distance D(n) between the object to be detected Fg present in the space on the detection region AA and the sensor electrode 12, and the signal value S(n) corresponding to the capacitance is acquired.

FIG. 5B is a schematic of the spatial coordinates of the object to be detected in the space on the detection region.

The processing circuit 23 extracts the spatial coordinates R(Rx, Ry, Rz) indicating the position of the object to be detected Fg in the space on the detection region AA illustrated in FIG. 5B, by using the generated signal values S(n) of the respective sensor electrodes 12.

FIGS. 5A and 5B illustrate an example in which the object to be detected Fg is present in the space on the detection region AA.

In the present disclosure, the spatial coordinates R(Rx, Ry, Rz) include first data Rx indicating the position in the first direction Dx in the detection region AA, second data Ry indicating the position in the second direction Dy in the detection region AA, and third data Rz indicating the position in the third direction Dz orthogonal to the first direction Dx and the second direction Dy.

In the present disclosure, the spatial coordinates R(Rx, Ry, Rz) indicate the position of the object to be detected Fg present in the space on the detection surface S when the surface of the front plate 15 is regarded as the detection surface S.

As described above, the detection device 1 according to the present disclosure detects the spatial coordinates of the position where the object to be detected Fg is present on the detection region AA, by detecting the capacitance generated on the sensor electrodes 12.

FIG. 6 is a schematic for explaining changes of the cursor. As illustrated in FIG. 6, the cursor Cs, the detection start plane SFA, and the determination plane H are provided on or above the detection surface S.

The cursor Cs is a figure displayed on the detection surface S to indicate the input position on or above the detection surface S that changes in the height direction in an area from the object to be detected Fg to the detection surface S.

The detection start plane SFA is set to a plane at a predetermined height where the object to be detected Fg is detectable from the detection surface S. When the object to be detected Fg approaches the detection surface S beyond the detection start plane SFA, the display device 200 displays the cursor Cs on the detection surface S. The detection start plane SFA is set to a predetermined position higher than the determination plane H. The upper limit of the position of the detection start plane SFA does not exceed the upper limit value of the sensor sensitivity.

The control device HD changes the size of the cursor Cs according to the distance from the detection surface S to the object to be detected Fg.

The determination plane H is a plane where the object to be detected Fg is at a height set by the user from the detection surface S. The control device HD processes the operation of the object to be detected Fg approaching the detection surface S beyond the determination plane H as an input to the detection device 1. The determination plane H is set between the detection surface S and the detection start plane SFA. The height of the determination plane H is determined according to the size of the object to be operated BT. The determination plane closer to the detection surface than the detection start plane is set at a distance from the detection surface.

The height of the determination plane H is adjusted by the operation performed on the setting input processor 50. The height of the determination plane H may be automatically adjusted by acquiring data, such as the size of the object to be operated BT, by the user application processor 52.

When the object to be detected Fg is present farther away from the detection surface S than the detection start plane SFA, the cursor Cs is not displayed on the detection surface S.

When the object to be detected Fg is present between the detection start plane SFA and the determination plane H, the display form of the cursor Cs changes with respect to the height direction of the front plate 15. The cursor Cs becomes smaller as the distance from the detection surface S to the object to be detected Fg becomes smaller. The size of the cursor Cs is determined by the distance from the detection surface S to the object to be detected Fg.

When the object to be detected Fg is present between the determination plane H and the detection surface S, the display form of the cursor Cs changes with respect to the height direction of the front plate 15. When the object to be detected Fg is present between the determination plane H and the detection surface S, the cursor Cs becomes larger as the distance from the detection surface S to the object to be detected Fg becomes smaller. The size of the cursor Cs is determined by the distance from the detection surface S to the object to be detected Fg.

The display form of the cursor Cs is at least one or more of size, shape, color, and brightness. In the present disclosure, the display form of the cursor Cs when the object to be detected Fg is present between the determination plane H and the detection start plane SFA is a circular shape represented by a dotted line, for example. The display form of the cursor Cs when the object to be detected Fg is present between the determination plane H and the detection surface S is a black-filled circular shape, for example.

When the object to be detected Fg approaches the detection surface S beyond the determination plane H, the control device HD changes the display form of the cursor Cs such that the display form is different from the display form of the cursor Cs before the object to be detected Fg crosses the determination plane H.

This configuration enables the user to visually recognize the distance from the object to be detected Fg to the determination plane H. When the object to be detected Fg approaches the detection surface S from the determination plane H, the size of the cursor Cs changes. Therefore, the user can visually recognize the amount of pushing of the object to be detected Fg that has passed the determination plane H.

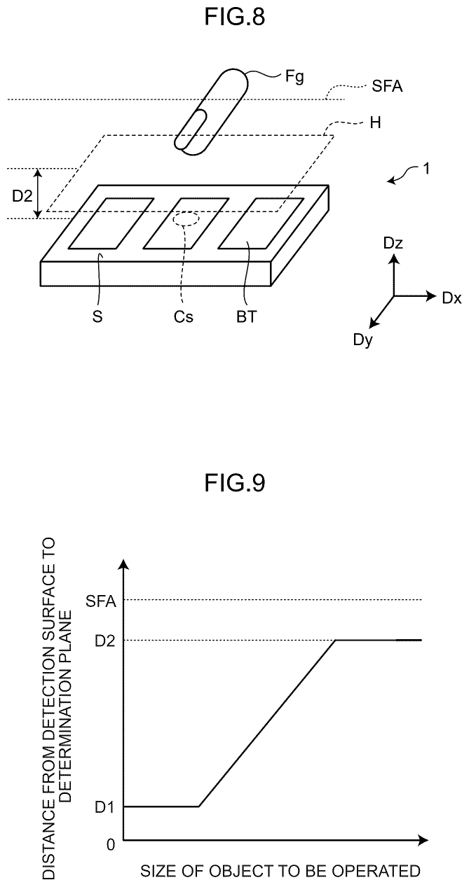

FIG. 7 is a schematic of the position of the determination plane when the size of the object to be operated is small. FIG. 8 is a schematic of the position of the determination plane when the size of the object to be operated is large. FIG. 9 is a graph indicating the relation between the size of the object to be operated and the distance from the detection surface to the determination plane.

As illustrated in FIGS. 7 and 8, the detection device 1 includes the object to be operated BT on the detection region AA, and the height of the determination plane H varies with the size of the object to be operated BT. The control device HD changes the distance at which the determination plane H is set from the detection surface S according to the size of the object to be operated BT displayed in the display region DA by the display device 200. In the present disclosure, a plurality of objects to be detected BT are projected onto the detection surface S in a matrix (row-column configuration).

The control device HD changes the distance at which the determination plane H is set from the detection surface S such that the distance from the determination plane H to the detection start plane SFA decreases as the size of the object to be operated BT displayed in the display region DA by the display device 200 increases. As illustrated in FIG. 7, when the size of the object to be operated BT is small, the distance from the detection surface S to the determination plane H is D1. If the distance from the detection surface S to the determination plane H is long, it is difficult for the user to align the position of the object to be detected Fg in the first direction Dx with the object to be operated BT. For this reason, the determination plane H is set to a position close to the detection surface S.

As illustrated in FIG. 8, when the size of the object to be operated BT is large, the distance from the detection surface S to the determination plane H is D2. In this case, even if the distance from the detection surface S to the determination plane H is long, the user can align the position of the object to be detected Fg in the first direction Dx with the object to be operated BT. For this reason, the determination plane H is set to a position far from the detection surface S.

As illustrated in FIG. 9, the distance from the detection surface to the determination plane increases as the size of the object to be operated BT increases within a certain range of the size of the object to be operated BT. In other words, the height of the determination plane H is variable depending on the size of the object to be operated BT. The height of the determination plane H does not necessarily linearly change with respect to the size of the object to be operated BT.

Therefore, the user can recognize that the position of the determination plane H varies depending on the size of the object to be operated BT.

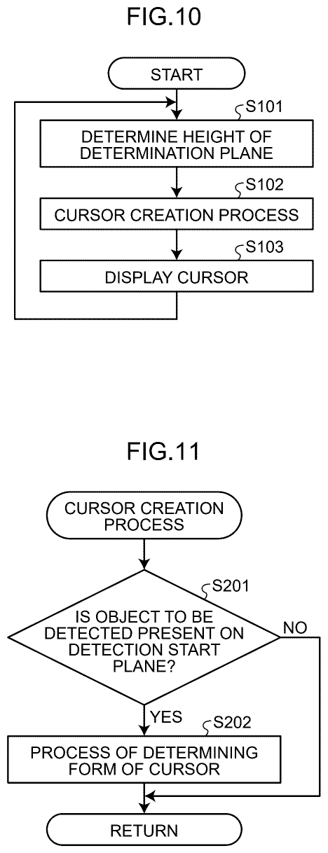

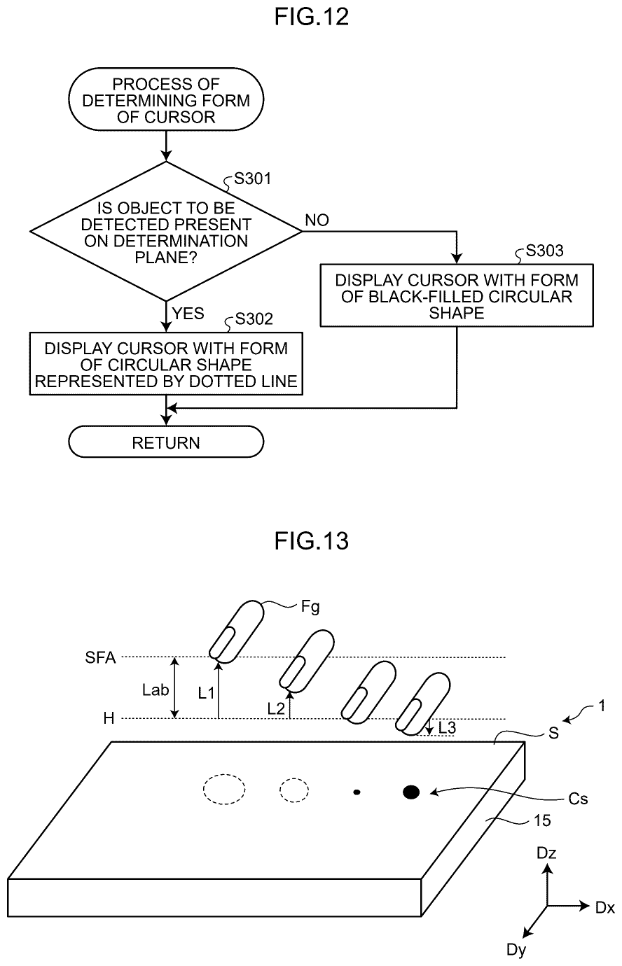

FIG. 10 is a flowchart of an example of a process of displaying the cursor in the detection device according to the embodiment. FIG. 11 is a sub-flowchart of an example of a cursor creation process illustrated in FIG. 10. FIG. 12 is a sub-flowchart of an example of a process of determining the type or size of the cursor illustrated in FIG. 11.

As illustrated in FIG. 10, the coordinate extractor 45 transmits calculated coordinate data to the control device HD at Step S101. The cursor display processor 51 determines the height of the determination plane H based on the coordinate data.

The cursor display processor 51 performs a process of creating the cursor Cs at Step S102. The process of creating the cursor Cs will be described later in detail with reference to FIG. 11.

The cursor display processor 51 displays the cursor Cs on the detection surface S at Step S103. The cursor Cs is displayed simultaneously with an application screen.

As illustrated in FIG. 11, the determination processor 46 determines whether the object to be detected Fg is present on the detection start plane SFA at Step S201.

If the determination processor 46 determines that the object to be detected Fg is present on the detection start plane SFA (Yes at Step S201), the cursor display processor 51 performs a process of determining the display form of the cursor Cs at Step S202. The process of determining the display form of the cursor Cs will be described later in detail with reference to FIG. 12.

If the determination processor 46 determines that the object to be detected Fg is not present on the detection start plane SFA (No at Step S201), the cursor display processor 51 does not perform the process of determining the display form of the cursor Cs at Step S202. In this case, the cursor Cs is not displayed on the detection surface S.

As illustrated in FIG. 12, the determination processor 46 determines whether the object to be detected Fg is present on the determination plane H at Step S301.

If the determination processor 46 determines that the object to be detected Fg is not present on the determination plane H (No at Step S301), the cursor display processor 51 displays the cursor Cs with a circular shape represented by a dotted line on the detection surface S at Step S302.

When the object to be detected Fg approaches the determination plane H in the third direction Dz at Step S302, the size of the third data Rz decreases. At the same time, the cursor display processor 51 displays the cursor Cs with a smaller size.

Subsequently, if the determination processor 46 determines that the object to be detected Fg is present on the determination plane H (Yes at Step S301), the cursor display processor 51 displays the cursor Cs with a black-filled circular shape on the detection surface S at Step S303.

When the object to be detected Fg approaches the detection surface S in the third direction Dz at Step S303, the size of the third data Rz increases. At the same time, the cursor display processor 51 displays the cursor Cs with a larger size.

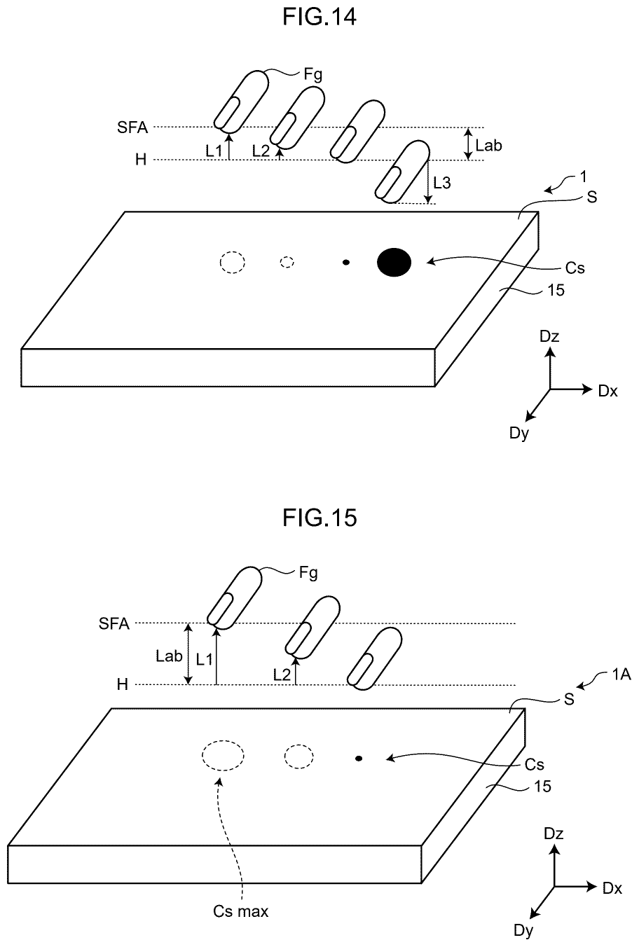

Next, the method for determining the size of the cursor Cs is described. FIG. 13 is a schematic for explaining the method for determining the cursor size when the distance from the determination plane to the detection start plane is long. FIG. 14 is a schematic for explaining the method for determining the cursor size when the distance from the determination plane to the detection start plane is short.

The control device HD performs control such that the cursor Cs becomes smaller as the distance from the detection surface S to the object to be detected Fg becomes smaller for the object to be detected Fg present between the determination plane H and the detection start plane SFA. The control device HD performs control such that the cursor Cs becomes larger as the distance from the detection surface S to the object to be detected Fg becomes smaller for the object to be detected Fg present between the determination plane H and the detection surface S.

As illustrated in FIGS. 13 and 14, the size of the cursor Cs is determined by the distance from the determination plane H to the object to be detected Fg and is calculated according to Expression 1 below. The size of the cursor Cs when the object to be detected Fg is present on the determination plane H is the same independently of whether a distance Lab from the determination plane H to the detection start plane SFA is large or small.

$$Cs = Cs\_per \times Lx \qquad ( Expression 1 )$$

where Cs_per is the amount of change in size of the cursor Cs per unit distance, and Lx is the distance from the determination plane H to the object to be detected Fg.

The distance Lx is defined to be positive in the direction from the determination plane H to the detection start plane SFA and negative in the direction from the determination plane H to the detection surface S. In the present disclosure, when the size of the cursor Cs corresponds to the positive direction, the display form of the cursor Cs is a circular shape represented by a dotted line. If the size of the cursor Cs corresponds to the negative direction, the display form of the cursor Cs is a circular shape filled in black.

As illustrated in FIGS. 13 and 14, when the distance Lx changes from L1 (=Lab) to L2 (distance from the determination plane H to the object to be detected Fg when the object to be detected Fg is present at a position in proximity to the determination plane H), the size of the cursor Cs decreases according to Expression 1 because the absolute value of the distance Lx decreases. When the distance from the detection start plane SFA to the determination plane H is short, the size of the cursor Cs when the object to be detected Fg is present on the detection start plane SFA is smaller than when the distance from the detection start plane SFA to the determination plane H is long.

As illustrated in FIGS. 13 and 14, when the distance Lx changes from L2 to L3 (distance from the determination plane H to the object to be detected Fg when the object to be detected Fg is present at a position beyond the determination plane H), the size of the cursor Cs increases according to Expression 1 because the absolute value of the distance Lx increases.

As illustrated in FIG. 14, when the distance from the detection start plane SFA to the determination plane H is short, the amount of change in size of the cursor Cs when the object to be detected Fg is present between the determination plane H and the detection surface S is larger than when the distance from the detection start plane SFA to the determination plane H is long.

### Modification of Embodiment

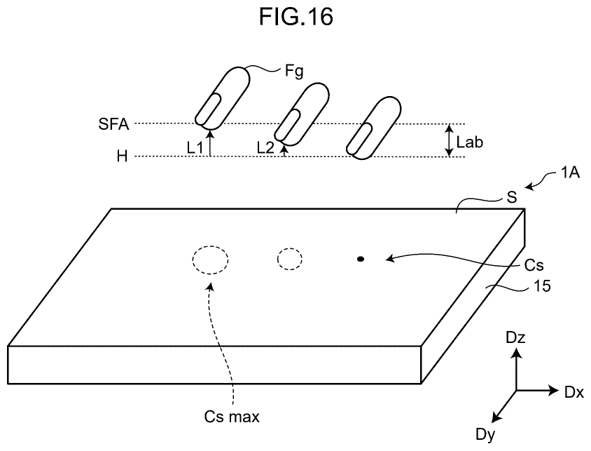

FIG. 15 is a schematic for explaining the method for determining the cursor size when the distance from the detection start plane to the determination plane is long and illustrates an example different from FIG. 13. FIG. 16 is a schematic for explaining the method for determining the cursor size when the distance from the detection start plane to the determination plane is short and illustrates an example different from FIG. 14. In the following description, the same components as those described in the embodiment above are denoted by the same reference numerals, and duplicate explanation thereof is omitted.

In a detection system 1A according to a modification of the embodiment, the control device HD performs control such that the cursor Cs becomes smaller as the distance from the detection surface S to the object to be detected Fg becomes smaller for the object to be detected Fg present between the determination plane H and the detection start plane SFA. The ratio of the change in size of the cursor Cs is determined by the ratio of the distance from the determination plane H to the object to be detected Fg to the distance from the determination plane H to the detection start plane SFA.

As illustrated in FIGS. 15 and 16, the size of the cursor Cs is determined by the ratio of the distance Lab from the detection start plane SFA to the determination plane H and is calculated according to Expression 2 below. The size of the cursor Cs when the object to be detected Fg is present on the detection start plane SFA and the determination plane H is the same independently of whether the distance Lab from the detection start plane SFA to the determination plane H is long or short.

$$Cs = Cs\_max \times Lx / Lab \qquad ( Expression 2 )$$

where Cs max is the size of the cursor Cs when the object to be detected Fg is present on the detection start plane SFA and is the maximum value of the size of the cursor Cs.

When the distance Lx changes from L1 to L2 in a case where the distance from the detection start plane SFA to the determination plane H is long as illustrated in FIG. 15, the amount of change in size of the cursor Cs per unit distance is smaller according to Expression 2 because the distance Lab from the detection start plane SFA to the determination plane H is larger.

When the distance Lx changes from L1 to L2 in a case where the distance from the detection start plane SFA to the determination plane H is short as illustrated in FIG. 16, the amount of change in size of the cursor Cs per unit distance is larger according to Expression 2 than in a case where the distance from the detection start plane SFA to the determination plane H is long because the distance Lab from the detection start plane SFA to the determination plane H is smaller.

While exemplary embodiments according to the present disclosure have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure.

What is claimed is:

1. A detection system comprising:
a detection device comprising:
a plurality of sensor electrodes provided in a detection region; and
a detection circuit configured to detect capacitance of each of the sensor electrodes;
a display device having a display region overlapping the detection region; and
a control device configured to control the detection device and the display device, wherein
the detection device is configured to calculate spatial coordinates of an object to be detected, and
the control device is configured to control the display device so as to display a cursor at a position where the calculated spatial coordinates of the object to be detected are projected onto the display region.

2. The detection system according to claim 1, wherein
a surface on which the sensor electrodes are provided is a detection surface, and
the display device is configured to, when the object to be detected approaches the detection surface beyond a detection start plane, display the cursor on the detection surface, wherein the detection start plane is defined at a height where the object to be detected is detectable and at a predetermined height from the detection surface.

3. The detection system according to claim 2, wherein the control device changes a size of the cursor in accordance with a distance from the detection surface to the object to be detected.

4. The detection system according to claim 3, wherein the cursor becomes smaller as the distance from the detection surface to the object to be detected becomes smaller.

5. The detection system according to claim 3, wherein the cursor becomes larger as the distance from the detection surface to the object to be detected becomes smaller.

6. The detection system according to claim 4, wherein the size of the cursor is determined by the distance from the detection surface to the object to be detected.

7. The detection system according to claim 5, wherein the size of the cursor is determined by the distance from the detection surface to the object to be detected.

8. The detection system according to claim 2, wherein
a determination plane closer to the detection surface than the detection start plane is set at a distance from the detection surface, and
the control device is configured to, when the object to be detected approaches the detection surface beyond the determination plane, change a display form of the cursor such that the display form is different from a display form of the cursor before the object to be detected crosses the determination plane.

9. The detection system according to claim 8, wherein the display form of the cursor is at least one or more of size, shape, color, and brightness.

10. The detection system according to claim 9, wherein the control device is configured to change the distance at which the determination plane is set from the detection surface in accordance with a size of an object to be operated that is displayed in the display region by the display device.

11. The detection system according to claim 8, wherein the control device is configured to change the distance at which the determination plane is set from the detection surface such that the distance from the determination plane to the detection start plane decreases as a size of an object to be operated that is displayed in the display region by the display device increases.

12. The detection system according to claim 2, wherein
a determination plane closer to the detection surface than the detection start plane is set at a distance from the detection surface,
the control device is configured to perform control such that the cursor becomes smaller as the distance from the detection surface to the object to be detected becomes smaller for the object to be detected present between the determination plane and the detection start plane, and
the control device is configured to perform control such that the cursor becomes larger as the distance from the detection surface to the object to be detected becomes smaller for the object to be detected present between the determination plane and the detection surface.

13. The detection system according to claim 2, wherein
a determination plane closer to the detection surface than the detection start plane is set at a distance from the detection surface,
the control device performs control such that the cursor becomes smaller as the distance from the detection surface to the object to be detected becomes smaller for the object to be detected present between the determination plane and the detection start plane, and
the ratio of change in size of the cursor is determined by the ratio of the distance from the determination plane to the object to be detected to the distance from the determination plane to the detection start plane.
